(19) United States
(12) Patent Application Publication
(10) Pub. No.: US 2026/0323468 A1
(43) Pub. Date: Oct. 15, 2026

(54) USER EQUIPMENT CONFIGURED FOR CONDITIONAL HANDOVER WITH DUAL CONNECTIVITY

(71) Applicant: NOKIA TECHNOLOGIES OY, Espoo (FI)

(72) Inventors: Halit Murat GÜRSU, Munich (DE); Frédéric RATOVELOMANANA, Paris (FR); Srinivasan SELVAGANAPATHY, Bangalore (IN); Umur KARABULUT, Munich (DE); Jedrzej STANCZAK, Wroclaw (PL); Ahmad AWADA, Munich (DE); Arled PAPA, Munich (DE)

(21) Appl. No.: 19/483,895

(22) PCT Filed: Apr. 17, 2024
(86) PCT No.: PCT/EP2024/060365

§ 371 Date: Nov. 12, 2025

(30) Foreign Application Priority Data
May 12, 2023 (IN) 202341033649

(51) Int. Cl. H04W 36/36; H04W 36/00; H04W 36/30

(52) U.S. Cl. CPC H04W 36/362; H04W 36/0058; H04W 36/0069; H04W 36/304

(57) ABSTRACT

A user equipment is provided, that is configured for dual connectivity and also configured to support conditional handover (CHO). The user equipment is configured to receive a first configuration for a source primary cell of a master cell group and a source primary cell of a secondary cell group, receive a second configuration for a target primary cell of the master cell group and a target primary cell of the secondary cell group, receive an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and measure the source primary cell of the secondary cell group to determine if the measurement condition is fulfilled.

### TECHNICAL FIELD

Various example embodiments relate generally to telecommunications, and to a user equipment and network node configured for conditional handover (CHO) with dual connectivity.

### BACKGROUND

In 3GPP Release 16, the user equipment (UE) is configured with a conditional handover (CHO) command containing the target cell configuration and a condition to execute the handover for one or multiple target cells.

The CHO configuration received at the UE from the network allows the UE to perform a handover without the need to involve the network, if conditions in another cell become better than the serving cell in which the UE is currently located. This provides a much more efficient and robust mobility solution for handover, especially in cases when the UE is moving between many different cells. The UE receives a CHO configuration from the network, which includes an execution condition for CHO to take place from a serving cell to a target cell. The execution condition is that the target cell should be better than the serving cell in some way, for example the target cell has a better radio link quality or a better signal strength than the serving cell.

FIG. 1 shows a network 200 in which there are two master nodes 201 and 202 providing a UE 220 with access to primary cells 211 and 212, respectively. The master nodes 201 and 202 in this example are 5G gNBs. The network 200 also has smaller cells, belonging to a secondary cell group (SCG). Each primary cell of the SCG is known as a primary secondary cell (PSCell). Three PSCells 213, 214 and 215 are shown here for illustrative purposes, although there may be more in practice. Secondary nodes 203, 204 and 205 provide the UE 220 with access to the primary cells of the SCG (PSCells 213, 214 and 215, respectively).

If the UE 220 is configured for dual connectivity, it can be connected to both a master node and a secondary node simultaneously. For example, the UE 220 could have radio connectivity to both the master node 201 and the secondary node 203. Dual connectivity provides for much better and more reliable radio coverage, and in general a better user experience of the network.

The condition to execute a handover (CHO) is based on radio measurements made by the UE 220 of the neighbour cells to the current serving primary and secondary cells. The procedure is presented in the message flow diagram shown in FIG. 2.

Conditional handover (CHO) is designed so that the UE 220 can perform the handover without the need of the serving cell (for example the primary cell 211) triggering the handover execution after it receives a measurement report from the UE. At step 10, the UE 220 is configured with an execution condition for CHO to a target cell, for example the primary cell 212. Using radio measurements, the UE 220 evaluates the neighbour cells of the cell 212 versus a threshold, or versus the serving cell, in this case primary cell 211. Once the measurement comparing the neighbour cell to the threshold or the serving cell holds for a particular cell, the UE 220 performs a control to determine if this cell is an applicable cell. In other words, the UE 220 compares the cell ID that fulfills the event condition (and therefore becomes a suitable target cell for handover) with the cell ID configured in the CHO configuration. If the cell IDs match, the UE 220 executes the conditional handover and accesses the target cell.

A few examples of execution conditions are described below.

One execution condition is that a neighbour becomes offset better than a special cell. The network configures the UE 220 to compare all neighbour cells versus the serving primary secondary PSCell, for example 213. The event is triggered for the neighbour that is offset better than the special cell of the RAN node. If the MN 201 is configuring the event, the primary cell 211 is considered as the special cell. If the secondary node 203 is configuring the event, the PSCell 213 is the special cell of the SCG.

Another execution condition is that conditions in a neighbour cell become better than threshold.

In this case, the UE 220 is configured to measure a target frequency band for neighbour cells. For these measurements the UE 220 will not consider the serving cell, but rather the UE 220 will consider all cells except the serving cell. This execution condition is triggered if any cell except the serving cell becomes better than a threshold. This is done to ensure that UE 220 will not trigger this event too often, as it is expected that serving cell is usually above a threshold.

As explained above, the CHO comes with an execution condition, some of which are the events described above. However, the reporting configuration related to the event is changed to execution. Instead of triggering a report when the event is fulfilled, an execution is triggered.

In Release 17, CHO with a target secondary cell group (SCG) feature is standardized. Release 17 provides that the UE can access the target PSCell without evaluating the target PSCell measurements.

Release 18 is working on enabling CHO with target SCGs and there is now an evaluation condition for the target PSCell before the CHO execution.

However, there is currently no provision for when the serving cell becomes better than a threshold, or has better conditions than a neighbour cell. This situation could occur if the UE 220 were accessing a serving cell, for example the PSCell 214, and was configured to perform CHO but the serving PSCell 214 had better radio conditions than the other PSCells 213 and 215.

Currently there is no feasible solution in this situation because interference can result when the UE takes measurements from two PSCells very close in frequency. Furthermore, the UE could assess that one PSCell has better radio conditions than its neighbour, but those conditions may not be sufficiently good to maintain the radio link.

### SUMMARY OF THE INVENTION

Accordingly, an aspect of the present invention provides a user equipment configured for dual connectivity and configured to support conditional handover (CHO). The user equipment comprises at least one processor, and at least one memory including computer program code, wherein the at least one memory and the computer program code are configured, with the at least one processor, to cause the user equipment at least to receive a first configuration for a source primary cell of a master cell group and a source primary cell of a secondary cell group, receive a second configuration for a target primary cell of the master cell group and a target primary cell of the secondary cell group, receive an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and measure the source primary cell of the secondary cell group to determine if the measurement condition is fulfilled.

This means that the serving (source) primary cell of the secondary cell group and the target (candidate) primary cell of the secondary cell group can be the same PSCell and the UE can consider the source primary cell of the secondary cell group as a target cell for CHO.

In this way, conditional handover with dual connectivity is possible from the source primary cell and one PSCell to the target primary cell and the same PSCell if the measurement condition(s) is met. The UE can consider the serving PSCell as the candidate PSCell for CHO without the problems described above. This also makes conditional handover possible when the source PSCell and target PSCell are not the same cell but have overlapping coverage. It also allows the serving PSCell to be considered as the target PSCell when the serving PSCell is in the coverage area of two different primary cells of the master cell group.

The execution condition can also include an access condition for the target primary cell, so that the CHO with dual connectivity may only take place from the source primary cell of the master cell group and the PSCell to the target primary cell of the master cell group and the PSCell if the access condition for the target primary cell of the master cell group is met.

The measurement can include measuring the source primary cell of the secondary cell group and measuring at least one other cell in the secondary cell group, which could be a neighbour cell.

The UE can be further configured to perform CHO with dual connectivity to hand over from the source primary cell of the master cell group and the source primary cell of the secondary cell group to the target primary cell of the master cell group and the source primary cell of the secondary cell group if the measurement condition is fulfilled.

Performing a measurement can include measuring a reference signal signalled from the source primary cell of the secondary cell group to determine if the measurement condition is met. The measurement condition may be met or fulfilled if a signal strength of the source primary cell of the secondary cell group is higher than a predetermined threshold. Alternatively, performing a measurement can include comparing a signal measurement of the source primary cell of the secondary cell group with a signal measurement of at least one other cell in the secondary cell group, which could be a neighbour cell. The neighbour cell can be one of a plurality of neighbour cells that only comprise candidate cells. A candidate cell can be a cell for which the user equipment has received a target primary cell of a secondary cell group configuration. The secondary cell group configuration can be part of a CHO execution condition.

The execution condition can be that the signal measurement of the source primary cell of the secondary cell group is stronger than the signal measurement of all neighbour cells by an offset. Alternatively, it can be that a signal measurement of the source primary cell of the secondary cell group is not weaker by more than an offset than a strongest measurement from a neighbour cell.

In one embodiment, the user equipment can receive at least two configurations from the network for the execution condition. The configurations can be determined using different measurement methods. The user equipment can be further configured to receive an indication to measure the source primary cell of the secondary cell group for a specific measurement event.

The user equipment can be further configured to receive an indication comprising a list of candidate cells to be considered for the measurement condition.

The user equipment can also be configured to receive a configuration including an entering condition and a leaving condition for evaluating the source primary cell of the secondary cell group against a list of other primary cells of the secondary cell group or against a threshold.

In one aspect of the invention, an apparatus is provided that is configured for dual connectivity and configured to support conditional handover, CHO. The apparatus comprises means for receiving a first configuration for a source primary cell of a master cell group and a source primary cell of a secondary cell group, means for receiving a second configuration for a target primary cell of the master cell group and a target primary cell of the secondary cell group, means for receiving an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and means for measuring the source primary cell of the secondary cell group to determine if the measurement condition is fulfilled.

An aspect of the invention provides a master node for a mobile communications network, wherein the master node is configured to provide a user equipment with access to a source primary cell in a master cell group, and the network further comprises a target master node configured to provide the user equipment with access to a target primary cell in the master cell group. The network also includes a source secondary node configured to provide the user equipment with access to a source primary cell in a secondary cell group and a target secondary node configured to provide the user equipment with access to a target primary cell in the secondary cell group. The master node comprises at least one processor, and at least one memory including computer program code, wherein the at least one memory and the computer program code are configured, with the at least one processor, to cause the master node at least to send to the user equipment a first configuration for the source primary cell of the master cell group and a source primary cell of a secondary cell group, send to the user equipment a second configuration for the target primary cell of the master cell group and the target primary cell of the secondary cell group, send to the user equipment an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and send to the user equipment an instruction to measure the source primary cell of the secondary cell group to determine if the measurement condition is fulfilled.

The master node can be further configured to update the measurement condition if a serving (source) primary cell of the secondary cell group changes.

The master node can be further configured to receive an indication from the target master node of multiple measurement conditions including a measurement condition for considering the source primary cell of the secondary cell group as a serving cell and a measurement condition for not considering the source primary cell of the secondary cell group as the serving cell.

An aspect of the invention provides a method for a user equipment configured for dual connectivity and configured to support conditional handover, CHO, the method comprising receiving a first configuration for a source primary cell of a master cell group and a source primary cell of a secondary cell group, receiving a second configuration for a target primary cell of the master cell group and a target primary cell of the secondary cell group, receiving an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and measuring the source primary cell of the secondary cell group to determine if the measurement condition is fulfilled.

Another aspect of the invention provides a method for a mobile communications network, wherein the network comprises a source master node configured to provide a user equipment with access to a source primary cell in a master cell group, a target master node configured to provide the user equipment with access to a target primary cell in the master cell group, a source secondary node configured to provide the user equipment with access to a source primary cell in a secondary cell group, and a target secondary node configured to provide the user equipment with access to a target primary cell in the secondary cell group. The method comprises sending to the user equipment a first configuration for the source primary cell of the master cell group and the source primary cell of the secondary cell group, sending to the user equipment a second configuration for the target primary cell of the master cell group and the target primary cell of the secondary cell group, sending to the user equipment an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and sending to the user equipment an instruction to measure the source primary cell of the secondary cell group to determine if the measurement condition is fulfilled.

A further aspect of the invention provides a computer program product embodied on a distribution medium readable by a computer and comprising program instructions which, when the program is executed by an apparatus, cause the apparatus to carry out the method according to embodiments of the invention.

Another aspect of the invention provides a computer program product comprising program instructions which, when the program is executed by an apparatus, cause the apparatus to carry out the method according to embodiments of the invention.

An aspect of the invention provides a computer system, comprising one or more processors, at least one data storage, and one or more computer program instructions to be executed by the one or more processors embodiments of the invention.

### LIST OF FIGURES

The invention will now be described with reference to example embodiments, and to the accompanying drawings, in which:

FIG. 1 shows an example of a network in which CHO with dual connectivity can take place;

FIG. 2 is a message flow diagram representing conditional handover;

FIG. 3 is an example of a network to which embodiments of the invention could be applicable;

FIG. 4 is an example of a network to which embodiments of the invention are applicable;

FIG. 5 is a simplified schematic block diagram of network nodes according to an embodiment of the invention;

FIG. 6 is a simplified schematic block diagram of a user equipment according to an embodiment of the invention;

FIG. 7 is a flow diagram representing a method according to an embodiment of the invention;

FIG. 8 is a flow diagram representing a method according to an embodiment of the invention;

FIG. 9 is a message flow diagram representing a method according to an embodiment of the invention;

FIG. 10 is a block diagram schematically representing circuitry of a UE for performing a method according to an embodiment of the invention; and

FIG. 11 is a block diagram schematically representing circuitry of a device for performing a method according to an embodiment of the invention.

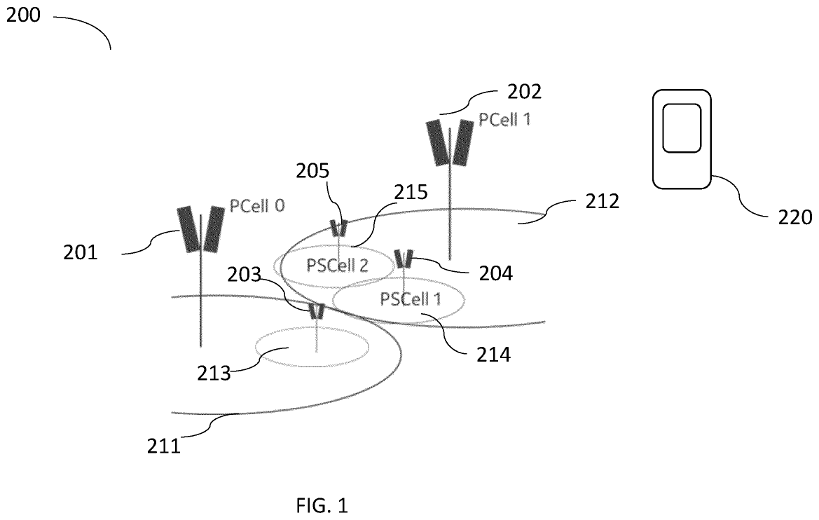

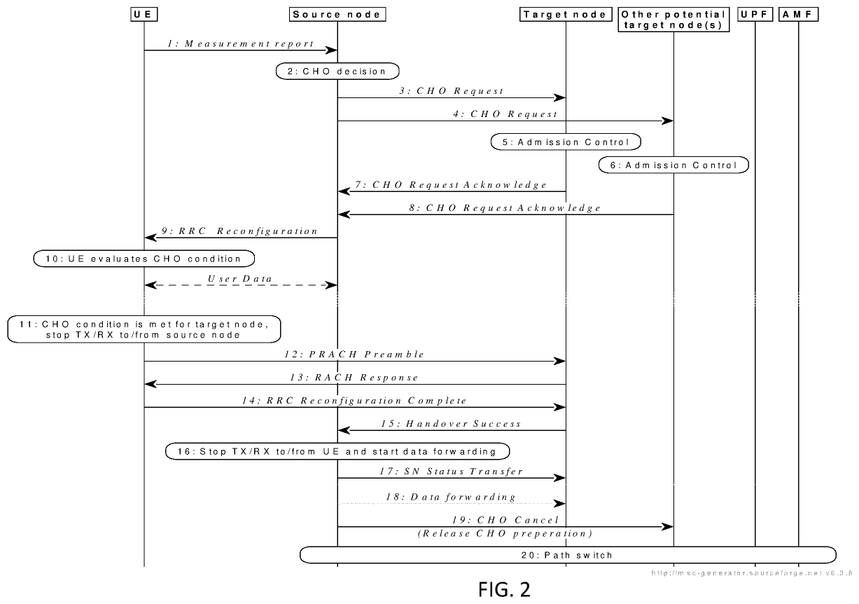

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments.

The embodiments described herein may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

The embodiments are not, however, restricted to the systems/RATs given as an example but a person skilled in the art may apply the solution to other communication systems/networks provided with necessary properties. Some examples of a suitable communication networks include a 5G network and/or a 6G network. The 3GPP solution to 5G is referred to as New Radio (NR). 6G is envisaged to be a further development of 5G. NR has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G may require bringing the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of work between core network operations and base station operations may vary depending on implementation. Thus, 5G networks architecture may be based on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other possible technology advancements to be used are Software-Defined Networking (SDN), Big Data, and all-IP, to mention only a few non-limiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrow-band (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)-using resource blocks within a normal LTE carrier, or in the unused resource blocks within a LTE carrier's guard-band- or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (12V), or in general to V2X or X2V communications.

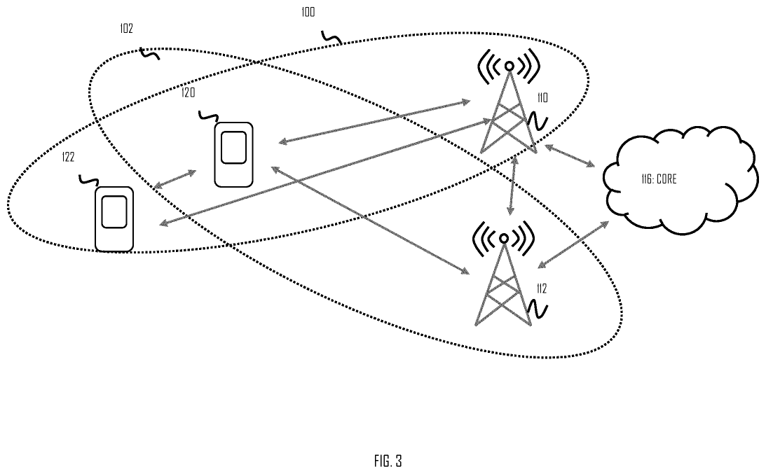

FIG. 3 illustrates an example of a communications network to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) 120 (one or more UEs) with wireless access to other networks such as the Internet. The wireless access may comprise downlink (DL) communication from the control node to the UE 120 and uplink (UL) communication from the UE 120 to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be a plurality of UEs 120, 122 in the system. Each of them may be served by the same or by different control nodes 110, 112. The UEs 120, 122 may communicate with each other, in case D2D communication interface is established between them.

The term “terminal device” or “UE” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface may be provided between access points. An interface between an LTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC), and there the core network may comprise e.g. an access and mobility management function (AMF) and a user plane function/gateway (UPF), to mention only a few. The AMF may handle termination of non-access stratum (NAS) signalling, NAS ciphering & integrity protection, registration management, connection management, mobility management, access authentication and authorization, security context management. The UPF node may support packet routing & forwarding, packet inspection and QoS handling, for example.

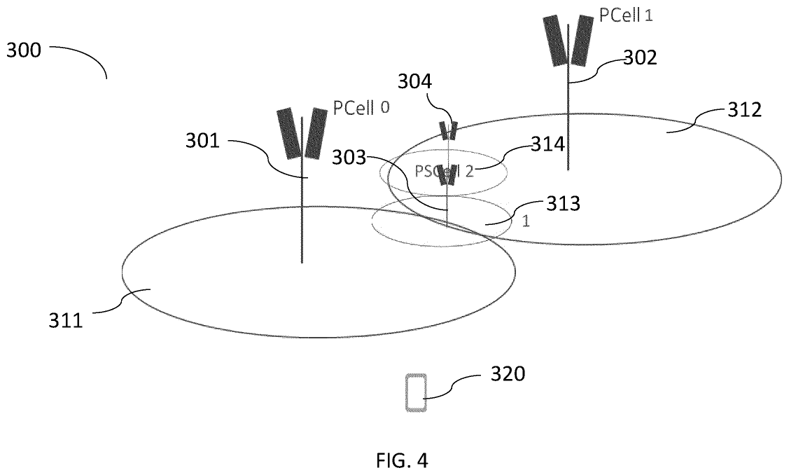

FIG. 4 schematically shows a network 300 in which example embodiments may operate. For the purposes of discussion, the network shown in FIG. 4 is a 5G network, however, the embodiments may also apply to any other current or future radio access technologies.

The network 300 includes two base stations or gNBs: master node (MN) 301 and a second master node (MN) 302. MN 301 and MN 302 provide a terminal device or user equipment (UE) 320 with access to primary cells 311 and 312, respectively, which belong to a primary or master cell group. The primary cells 311 and 312 are macro cells. Other network access nodes and cells in the primary cell group of the network 300 are not shown here for simplicity.

Secondary access nodes 303 and 304 provide access to small cells 313 and 314, respectively. The cells 313 and 314 are primary cells of a secondary cell group (SCG) and are known as primary secondary cells (PSCells). The PSCells 313 and 314 may be, for example, femto cells, pico cells, or any other kind of small cells. Having a SCG provides for a much better and more robust network coverage, as explained in the background section above. The PSCell 313 in the SCG is located in the coverage area of both cells 311 and 312 from the master cell group.

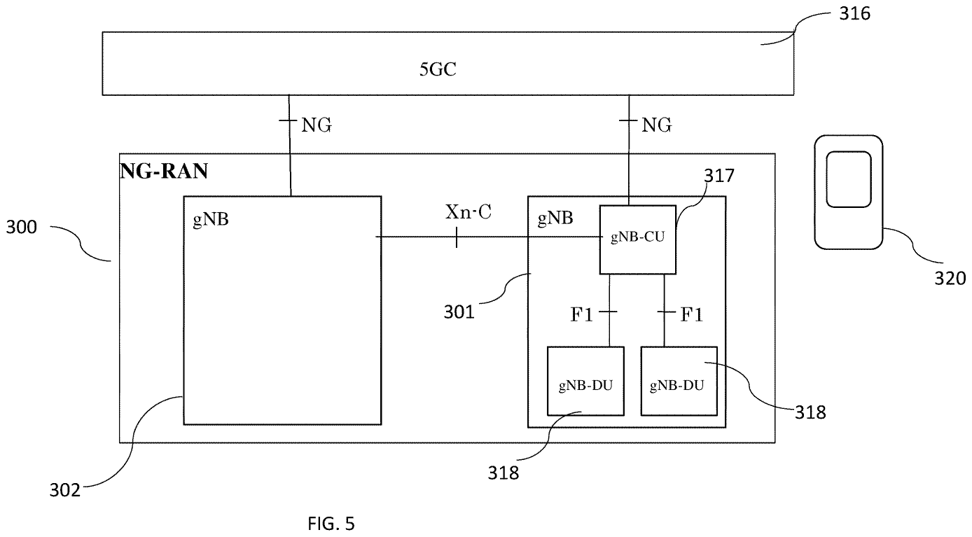

As mentioned, the master nodes 301 and 302 can be gNBs and are shown in more detail in FIG. 5. The master nodes 301 and 302 are connected via a Xn-C interface. Each master node 301, 302 is connected to the 5G core network via a NG interface and includes at least a central unit (CU) 317 and distributed units (DUs) 318, and provides radio access to the UE 320 over a user interface. The secondary nodes 303 and 304 can also be a type of gNB with a similar structure and configuration to the master nodes 301 and 302.

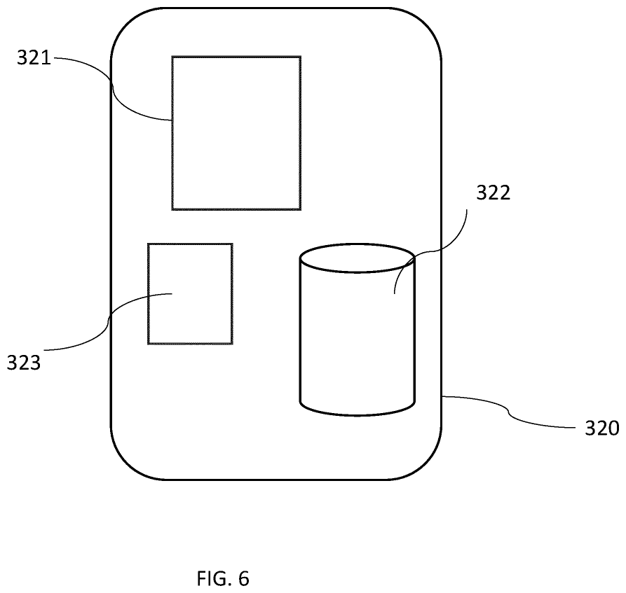

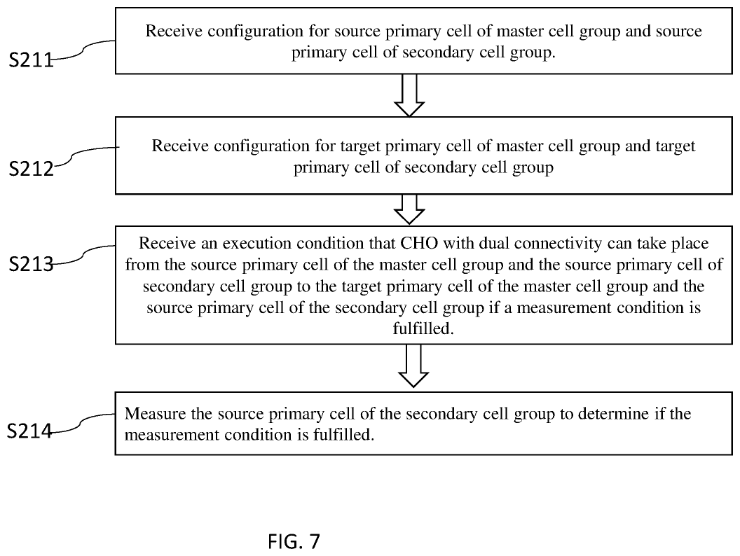

The UE 320 is configured for conditional handover (CHO). As explained in the background section above, CHO means that, once the UE 320 has received a CHO configuration from the network, it can perform handover from a serving or source cell to a target or candidate cell, provided at least one execution condition is met. The UE 320 is shown schematically in FIG. 6 and includes a processor 321, a memory 322 and a chipset or circuitry 323. The memory 322 includes computer program code for carrying out the method shown in FIG. 7.

The UE 320 is configured for dual connectivity, which means that it can be connected to both a serving primary cell of the master cell group and a serving primary cell of the secondary cell group. For example, the UE 320 could be connected to the serving or source primary cell 211 and to the serving PSCell 313.

As shown in FIG. 4, there could be a situation in which the serving or source PSCell 313 is located in the coverage areas of both primary cells 311 and 312. In this situation, when the UE 320 changes location to the coverage area of the primary cell 312 and needs to perform a CHO from the serving primary cell 311 to the primary cell 312 as a target primary cell, the source PSCell 313 can potentially become a target PSCell for dual connectivity (as can the PSCell 314 and other neighbour cells not shown in FIG. 4). However, as mentioned above, until now there has been no provision for this situation and the UE 320 has not been able to consider the serving cell PSCell 313 as a target cell. A method of CHO with dual connectivity for the UE 320 in the network 300 shown in FIG. 4 according to an embodiment is shown in FIG. 7. The network configures the UE 320 with an execution condition for the serving PSCell 313 that prepares it as a candidate or target PSCell for the target MN 302. In step S211 the UE 320 receives a configuration for the primary cell 311 as a source primary cell of the master cell group and the PSCell 313 as a source primary cell of the secondary cell group. In step S212 the UE 230 receives a configuration for the primary cell 312 as a target primary cell of the master cell group and a configuration for PSCell 213 as a target primary cell of the secondary cell group (configurations for other possible target cells may also be received, for example PSCell 214 from the SCG). In step S213 the UE 320 receives an execution condition that CHO with dual connectivity can take place from the source primary cell 311 and the PSCell 313 to the target primary cell 312 and the PSCell 313 if a measurement condition is fulfilled. The execution condition can include a determination that the PSCell 313 can be both a source primary cell of the SCG and a target primary cell of the SCG. In step S214 the UE 320 measures the PSCell 313 to determine if the measurement condition is fulfilled.

This allows CHO with dual connectivity to take place for the UE 320 from the source primary cell 311 and the PSCell 313 to the target primary cell 312 and the PSCell 313 if the measurement condition is fulfilled.

For example, the UE 320 can measure PSCell 313 and another PSCell of the secondary cell group (for example, a neighbour cell 314 of PSCell 313) to determine if the measurement condition is fulfilled. Alternatively, the UE 320 can measure the PSCell 313 and compare the measurement to a threshold to determine if the measurement condition is fulfilled.

The execution condition can also include the condition that an access condition for the target primary cell 312 is fulfilled, for example that the received signal strength of the primary cell 312 is greater than that of the source primary cell 311.

In this way, the PSCell 313 can be a serving cell and a target cell, and the PSCell 313 is recognised as a candidate PSCell for CHO with dual connectivity if the execution condition holds.

Monitoring of the serving PSCell 313 as a target PSCell in CHO with SCG execution can be done by the UE.

The execution condition for CHO is fulfilled if a measurement condition is fulfilled. There are various measurements that the UE 320 can make to check if the measurement condition is fulfilled. In one embodiment, the UE 320 checks if the signal strength measurement of the serving PSCell 313 is better than a predetermined threshold.

Alternatively, a new measurement event can be defined, in which the UE 320 compares the signal measurement of the serving PSCell 313 with the signal measurement of at least one of or all neighbour cells, for example the PSCell 314. In one embodiment, only the prepared cells or prepared neighbour cells are considered in the evaluation.

In another embodiment, the UE 320 checks if the signal measurement of the serving PSCell 313 is stronger than all other neighbour cell measurements by an offset. In a further embodiment, the UE 320 checks if the signal measurement of the serving PSCell 313 is not weaker by more than an offset than the strongest neighbour cell measurement.

For all embodiments, the network can configure more than one measurement condition for evaluating if the execution condition is fulfilled. For instance, the network can configure two conditions for the same serving PSCell 313, but each condition is evaluated with a different measurement quantity: one using reference signal received power (RSRP) and the other one using, for example, reference signal received quality (RSRQ). The execution condition in this case is fulfilled only if both conditions are met.

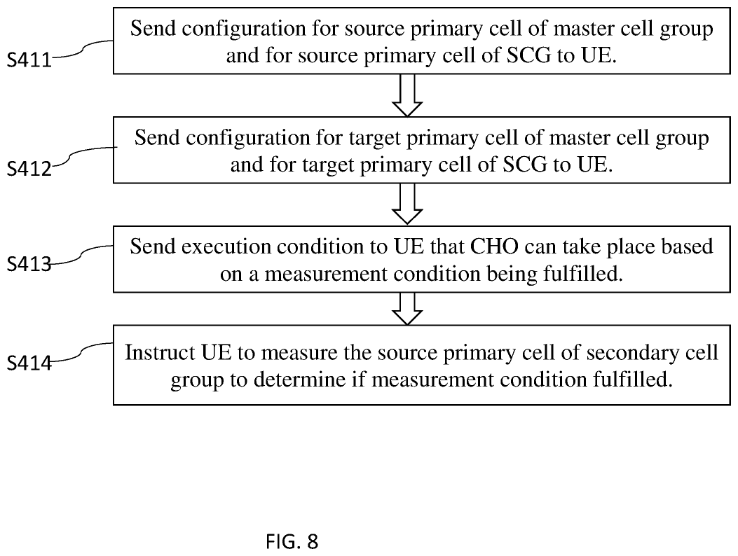

FIG. 8 shows a method according to an embodiment in which the network sends to the UE 320 a configuration for the primary cell 311 of master cell group and the PSCell 313 of the SCG in step S410. In step S411, the network sends the UE 320 a configuration for the target primary cell 312 of the master cell group and the PSCell 314 of the secondary cell group. In step S412 the network sends the UE 320 an execution condition that CHO with dual connectivity can take place from the source primary cell 311 and the PSCell 313 to the target primary cell 312 and the PSCell if a measurement condition is fulfilled. Some of the possible measurement conditions are outlined above. The network instructs the UE 320 at step S413 to perform a measurement on the PSCell 313 to determine if the measurement condition is fulfilled.

The network can then send a configuration to the UE 320 for CHO with dual connectivity from the source primary cell 311 and the PSCell 313 to the target primary cell 312 and the PSCell 313 if it is determined that measurement condition is fulfilled.

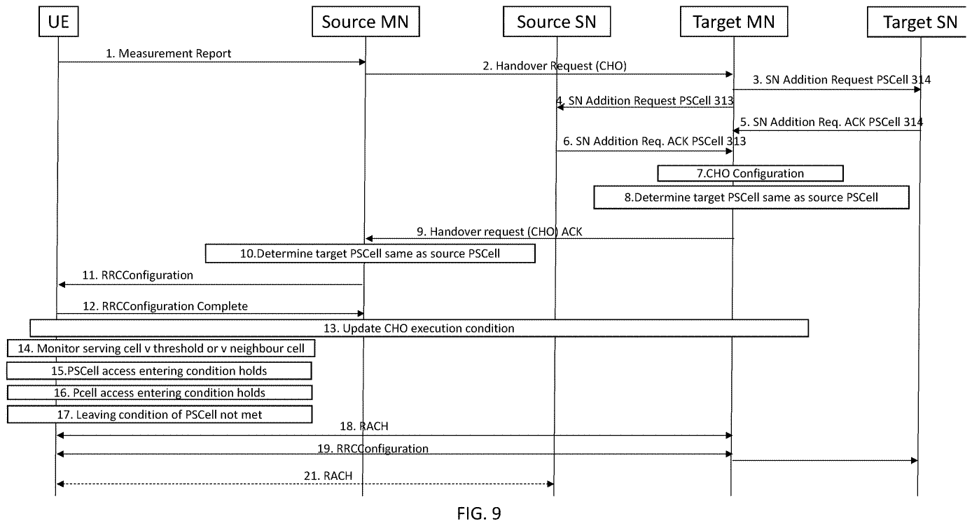

An embodiment will now be described with reference to the message flow diagram in FIG. 9.

At step 1 the UE 320 sends a measurement report indicating potential target primary cells and PSCells. The source MN 301 initiates the handover procedure and sends a handover request (Step 2) along with the measurements to the target MN 302. The target MN 302 uses the measurement reports from the UE 320 to determine which target secondary nodes (SNs) to contact and sends SN addition requests to the SN 303 and the SN 304, as well as other SNs in the network that are not shown (Steps 3-4). The target SNs reply with SN addition request ACK (Steps 5-6).

The target MN 302 forms the CHO configurations, for each target PSCell 313 and 314 (Step 7).

The target MN 302 then sets the execution condition for each target PSCell 313 and 314 (Step 8)

For the target PSCell 313, as it is the same as the serving PSCell 313, it indicates the new execution condition. The execution condition is determined by comparing the signal measurement of the serving PSCell 313 against a threshold, or the measurement of the serving PSCell 313 is compared against the signal measurement of the target PSCell (PSCell 313 versus PSCell 314).

The target MN 302 indicates at least one of the measurement object and related new reporting configuration (Step 9).

In one alternative embodiment, the target MN 302 does not indicate the execution condition to the source MN 301, so the source MN 301 may need to generate the reporting configuration by itself, similar to that described in step 8. In this example, the source MN 301 integrates the measurement object and the reporting configuration inside the source configuration relating it to the CHO configuration for each target PSCell 313 and 314 (step 10). This is indicated to the UE 320 with an RRCReconfiguration (Step 11). The UE 320 confirms the application of the configuration in step 12.

In case the serving PSCell 313 changes, then the network needs to update the execution condition (Step 13). For this, the target MN 302 may pre-emptively, send two execution conditions to the serving MN 301. One for the target PSCell as the serving PSCell 313, another for a target PSCell that is not the special cell of the SCG (the serving SCG cell PSCell 313) but instead the new serving special cell of the SCG. The source MN 301 can use these multiple conditions to set the right execution condition for the UE 320.

In another embodiment, the source MN 301 may generate the execution conditions by itself.

In a further embodiment, the source MN 301 may contact the target MN 302 to request an updated execution condition. The target MN 302 may then respond to the source MN 301 with an updated measurement configuration.

The UE 320 starts monitoring the execution condition as configured for each event (step 14). In one embodiment, the UE 320 measures the serving PSCell 313 versus a threshold or in an alternative embodiment, the UE 320 measures the serving PSCell 313 versus another PSCell, for example PSCell 314. The execution condition can include an entering and leaving condition for entering and leaving the target PSCell. Once the entering condition holds (Step 15), the UE 320 considers that target PSCell is accessible and starts monitoring the leaving condition. As long as the leaving condition is not met the UE 320 considers the target PSCell accessible. If the primary cell access condition holds (Step 16) and the leaving condition is not met (Step 17), then UE 320 accesses the target PSCell that fulfills the condition along with the target primary cell 312 (Step 18 to 21). The difference between the entering and leaving conditions is a hysteresis. This is illustrated below for one embodiment.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Hys is the hysteresis parameter for this event (i.e. hysteresis as defined within reportConfigNR for this event).

Thres—is the threshold set by the network.

A second embodiment is illustrated below.

Off is the offset parameter for this event (i.e. a7-Offset as defined within reportConfigNR for this event).

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

In an embodiment, the UE 320 may comprise the terminal device of a communication system, e.g. a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

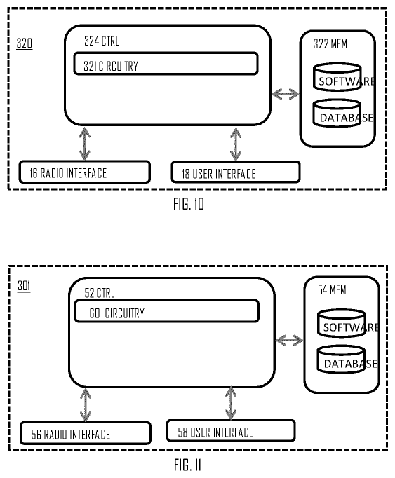

In an embodiment shown in FIG. 10, the circuitry in the UE 320 is shown schematically. The UE 320 may be caused to execute some of the functionalities of the above described processes, such as the steps shown in FIG. 7.

The UE 320 may further comprise a radio interface (TRX) 16 comprising hardware and/or software for realizing communication connectivity according to one or more communication protocols. The TRX may provide the apparatus with communication capabilities to access the radio access network, for example.

The apparatus may also comprise a user interface 18 comprising, for example, at least one keypad, a microphone, a touch display, a display, a speaker, etc. The user interface may be used to control the apparatus by the user.

The control circuitry 324 may comprise relevant circuitry/ies 321 for performing the functions, according to any of the embodiments.

An embodiment, as shown in FIG. 11, provides an apparatus 301 (and may also apply to the apparatus 302, 303, 304) comprising a control circuitry (CTRL) 52, such as at least one processor, and at least one memory 54 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 301 may be or be comprised in a network node, such as in gNB/gNB-CU/gNB-DU of 5G. In an embodiment, the apparatus is or is comprised in the network node 301. The apparatus may be caused to execute some of the functionalities of the above described processes, such as the steps of FIG. 8.

The apparatus may further comprise communication interface (TRX) 56 comprising hardware and/or software for realizing communication connectivity according to one or more communication protocols. The TRX may provide the apparatus with communication capabilities with at least one user equipment, for example.

The apparatus may also comprise a user interface 58 comprising, for example, at least one keypad, a microphone, a touch display, a display, a speaker, etc. The user interface may be used to control the apparatus by the user.

The control circuitry 52 may comprise a circuitry 60 for carrying out the method steps according to any of the embodiments described herein.

In an embodiment, a CU-DU (central unit-distributed unit) architecture is implemented. In such case the apparatus 50 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the radio node may be stand-alone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 130 or 131 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

A term non-transitory, as used herein, is a limitation of the medium itself (i.e. tangible, not a signal) as opposed to a limitation on data storage persistency (e.g. RAM vs. ROM). As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g, procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Although the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A user equipment configured for dual connectivity and configured to support conditional handover, CHO, the user equipment comprising:
at least one processor, and
at least one memory including computer program code, wherein the at least one memory and the computer program code are configured, with the at least one processor, to cause the user equipment at least to:
receive a first configuration for a source primary cell of a master cell group and a source primary cell of a secondary cell group,
receive a second configuration for a target primary cell of the master cell group and a target primary cell of the secondary cell group,
receive an execution condition that CHO with dual connectivity can take place from the source primary cell of the master cell group and the source primary cell of the secondary cell group to the target primary cell of the master cell group and the source primary cell of the secondary cell group if a measurement condition is fulfilled,
measure the source primary cell of the secondary cell group to determine if the measurement condition is fulfilled, and
perform CHO with dual connectivity to hand over from the source primary cell of the master cell group and the source primary cell of the secondary cell group to the target primary cell of the master cell group and the source primary cell of the secondary cell group if the measurement condition is fulfilled.

2. The user equipment according to claim 1, wherein performing a measurement comprises measuring a reference signal signalled from the source primary cell of the secondary cell group to determine if said measurement condition is met.

3. The user equipment according to claim 1, wherein the measurement condition is fulfilled if a signal strength of the source primary cell of the secondary cell group is higher than a predetermined threshold.

4. The user equipment according to claim 1, wherein performing a measurement comprises comparing a signal measurement of the source primary cell of the secondary cell group with a signal measurement of at least one other cell in the secondary cell group.

5. The user equipment according to claim 4, wherein the at least one other cell is a neighbour cell.

6. The user equipment according to claim 5, wherein a neighbour cell is one of a plurality of neighbour cells that only comprise candidate cells,

7. The user equipment according to claim 6, wherein a candidate cell is a cell for which the user equipment has received a target primary cell of a secondary cell group configuration.

8. The user equipment according to claim 7, wherein the secondary cell group configuration is part of a CHO execution condition.

9. The user equipment according to claim 1, wherein the execution condition is that the signal measurement of the source primary cell of the secondary cell group is stronger than the signal measurement of all neighbour cells by an offset.

10. The user equipment according to claim 1, wherein a signal measurement of the source primary cell of the secondary cell group is not weaker by more than an offset than a strongest measurement from a neighbour cell.

11. The user equipment according to claim 1, wherein the user equipment receives at least two configurations from the network for the execution condition.

12. The user equipment according to claim 11, wherein the configurations are determined using different measurement methods.

13. The user equipment according to claim 1, wherein the user equipment is further configured to receive an indication to measure the source primary cell of the secondary cell group for a specific measurement event.

14. The user equipment according to claim 1, wherein the user equipment is further configured to receive an indication comprising a list of candidate cells to be considered for the measurement condition.

15. The user equipment according to claim 1, wherein the user equipment is further configured to receive a configuration including an entering condition and a leaving condition for evaluating the source primary cell of the secondary cell group against a list of other primary cells of the secondary cell group or against a threshold.

16. An apparatus configured for dual connectivity and configured to support conditional handover, CHO, the apparatus comprising:
means for receiving a first configuration for a source primary cell of a master cell group and a source primary cell of a secondary cell group;
means for receiving a second configuration for a target primary cell of the master cell group and a target primary cell of the secondary cell group;
means for receiving an execution condition that CHO with dual connectivity can take place from the source primary cell of the master cell group and the source primary cell of the secondary cell group to the target primary cell of the master cell group and the source primary cell of the secondary cell group if a measurement condition is fulfilled;
means for measuring the source primary cell of the secondary cell group to determine if the measurement condition is fulfilled; and
means for performing CHO with dual connectivity to hand over from the source primary cell of the master cell group and the source primary cell of the secondary cell group to the target primary cell of the master cell group and the source primary cell of the secondary cell group if the measurement condition is fulfilled.

17. A master node for a mobile communications network, wherein the master node is configured to provide a user equipment with access to a source primary cell in a master cell group, wherein the master node comprises:
at least one processor, and
at least one memory including computer program code, wherein the at least one memory and the computer program code are configured, with the at least one processor, to cause the master node at least to:
send to the user equipment a first configuration for the source primary cell of the master cell group and a source primary cell of a secondary cell group,
send to the user equipment a second configuration for a target primary cell of the master cell group and a target primary cell of the secondary cell group,
send to the user equipment an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and
send to the user equipment an instruction to measure the source primary cell of the secondary cell group to determine if the measurement condition is fulfilled.

18. The master node according to claim 18, wherein the master node is further configured to update the measurement condition if a serving primary cell of the secondary cell group changes.

19. The master node according to claim 18, wherein the master node is further configured to receive an indication from the target master node of multiple measurement conditions including a measurement condition for considering the source primary cell of the secondary cell group as a serving cell and a measurement condition for not considering the source primary cell of the secondary cell group as the serving cell.

20. A method for a user equipment configured for dual connectivity and configured to support conditional handover, CHO, the method comprising:
receiving a first configuration for a source primary cell of a master cell group and a source primary cell of a secondary cell group;
receiving a second configuration for a target primary cell of the master cell group and a target primary cell of the secondary cell group;
receiving an execution condition that CHO with dual connectivity can take place from the source primary cell of the master cell group and the source primary cell of the secondary cell group to the target primary cell of the master cell group and the source primary cell of the secondary cell group if a measurement condition is fulfilled;
measuring the source primary cell of the secondary cell group to determine if the measurement condition is fulfilled; and
performing CHO with dual connectivity to hand over from the source primary cell of the master cell group and the source primary cell of the secondary cell group to the target primary cell of the master cell group and the source primary cell of the secondary cell group if the measurement condition is fulfilled.

21. A method for a mobile communications network, wherein the network comprises
a source master node configured to provide a user equipment with access to a source primary cell in a master cell group,
a target master node configured to provide the user equipment with access to a target primary cell in the master cell group,
a source secondary node configured to provide the user equipment with access to a source primary cell in a secondary cell group, and
a target secondary node configured to provide the user equipment with access to a target primary cell in the secondary cell group,
the method comprising:
sending to the user equipment a first configuration for the source primary cell of the master cell group and the source primary cell of the secondary cell group,
sending to the user equipment a second configuration for the target primary cell of the master cell group and the target primary cell of the secondary cell group,
sending to the user equipment an execution condition that CHO with dual connectivity can take place from the source primary cell of the master cell group and the source primary cell of the secondary cell group to the target primary cell of the master cell group and the source primary cell of the secondary cell group if a measurement condition is fulfilled, and
sending to the user equipment an instruction to measure the source primary cell of the secondary cell group to determine if the measurement condition is fulfilled.

22. A computer program product embodied on a distribution medium readable by a computer and comprising program instructions which, when the program is executed by an apparatus, cause the apparatus to carry out the method according to claim 20.

23. A computer program product comprising program instructions which, when the program is executed by an apparatus, cause the apparatus to carry out the method according to claim 20.

24. A computer system, comprising:
one or more processors;
at least one data storage, and
one or more computer program instructions to be executed by the one or more processors in association with the at least one data storage for carrying out a method according to claim 20.

25. A computer program product embodied on a distribution medium readable by a computer and comprising program instructions which, when the program is executed by an apparatus, cause the apparatus to carry out the method according to claim 21.

26. A computer program product comprising program instructions which, when the program is executed by an apparatus, cause the apparatus to carry out the method according to claim 21.

27. A computer system, comprising:
one or more processors;
at least one data storage, and
one or more computer program instructions to be executed by the one or more processors in association with the at least one data storage for carrying out a method according to claim 21.
